(19) United States
(12) Patent Application Publication
(10) Pub. No.: US 2002/0048081 A1
(43) Pub. Date: Apr. 25, 2002

(54) FABRICABLE REAR PROJECTION-TYPE MULTISCREEN FIXING DEVICE

(76) Inventor: JONG HOON LEE, SEOUL (KR)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 08/957,320

(22) Filed: Nov. 6, 1997

(30) Foreign Application Priority Data
Nov. 26, 1996 (JP) 41995

(51) Int. Cl. G03B 21/60

(52) U.S. Cl. 359/456

(57) ABSTRACT

A fixing device for fabricable rear projection-type multiscreens that increases the connecting strength of the screens and by minimalizes the space between adjacent screens. The connecting mechanism includes metal membrane-type connecting pieces that are less than 0.5 mm in thickness and are inserted between adjacent screens. Heat is then applied through the connecting pieces so the sides of the screens fuse together when the connecting pieces melt together. The connecting pieces are connected and fixed to partitioning plates with fixing bolts using fixing brackets.

### BRIEF DESCRIPTION OF DRAWINGS

FIG. 1 is the perspective overview of the present invention.

FIG. 2 is the make-up view showing the past fabricable rear projection-type multiscreen.

FIG. 3 is the perspective view showing the fabricable rear- projection multiscreen of the design under the present invention.

FIG. 4 is the sectional make-up view showing the fixed condition of the design.

FIG. 5 is the sectional make-up view showing the stationary condition and the completed state of the present invention(design).

FIG. 6 is the elevational make-up view of the multiscreen of the present invention (design).

*Code Numbers of Major Portions of the Drawings*

| | | | |
|---|---|---|---|
| 10: | Multiscreen | 10: | Screen |
| 12, 13: | Fixing brackets | 14, 15: | Fixing bolts |
| 16: | Partitioning Plate | 20: | Connecting Pin |
| 21: | Electrical Heater. | | |

### DETAILED DESCRIPTION OF THE INVENTION (DESIGN)

The present invention (design) relates to a device fixing the fabricable rear projection type multiscreens. For a more detailed description, the present invention (design) relates to the device fixing the fabricable rear projection type multiscreens that enhance the commercial value of the screens by improving the mechanism of many screens to connected to increase the screens' connecting strength and to narrow the intervals to the minimum between screens for the fabricable rear projection type of the computer or the projector.

Generally, for the rear projection types of various computers or projectors, it is absolutely required to enlarge the picture plane.

In this case, it was prerequisite that screens should be enlarged or that a considerable distance between screens and the projector, but because of the narrow space, it was not only difficult to maintain the condition mentioned above but, even if the said condition is preceded, the picture plane was not clear.

Consequently, when the picture plane was made to the desired size, the picture plane of projection was alloted to the desired size, and the alloted unit picture plane was provided with an independent projector which was used for projection of this type.

However, in this case, beam intervention between projectors were serious and because of the rims between the alloted screens, the screens were not easily connected to one another. Also it was not easy to additionally install and fabricate a unit screen on the left and right or above and below in order to replace each unit screen or to widen the picture plane.

In order to rectify and complement these problems, this inventor applied for a utility model patent No. 93-7941 (Announcement No. 95-6746 and, as shown in FIG. 2 of the drawings as attached, “T” shape transparent acryl rim 2 is inserted between screens 1 and bolt 5 is fastened and fixed thereon and at the same time partitioning plate 6 is fixed by inserting “T” shape transparent acryl rim 2 between screens 1 and by making use of fixing plates 3, 4 and 4 which are to be fixed at the rear of screens 1 mentioned above.

In the case of the previous design mentioned above, however, the said problems could have been solved by fabricating screens 1 strongly but because the interval is too wide between screens 1, i. e. , because the interval equivalent to the thickness of transparent acryl rim 2 inevitably occurred, clear connecting lines were formed on the whole picture plane of the projector.

Because the mechanism as mentioned above must be composed of a number of connecting screens, connecting lines would inevitably occurred while screens were connected to one another but because the thickness of transparent acryl rim 2 was too wide due to the mechanism of transparent acryl rim 2 that connected screens, a rim of the similar thickness occurred on the whole picture plane.

Therefore, this invention (design) is to rectify and complement this inventor's previous invention with consideration given to the problems mentioned above. The object of this invention is to provide fixing devices for fabricable rear projection type screens that can make screens strong, easily fabricable, connectible and capable of narrowing to minimum of the connecting intervals between the said screens.

The present invention which is to attain this object is characterized by the device to equip connecting pieces of membrane type between screens and at the same time fasten and fix them by heat fusion.

Below is a detailed description through the attached drawings of an example of desirable execution of the present invention.

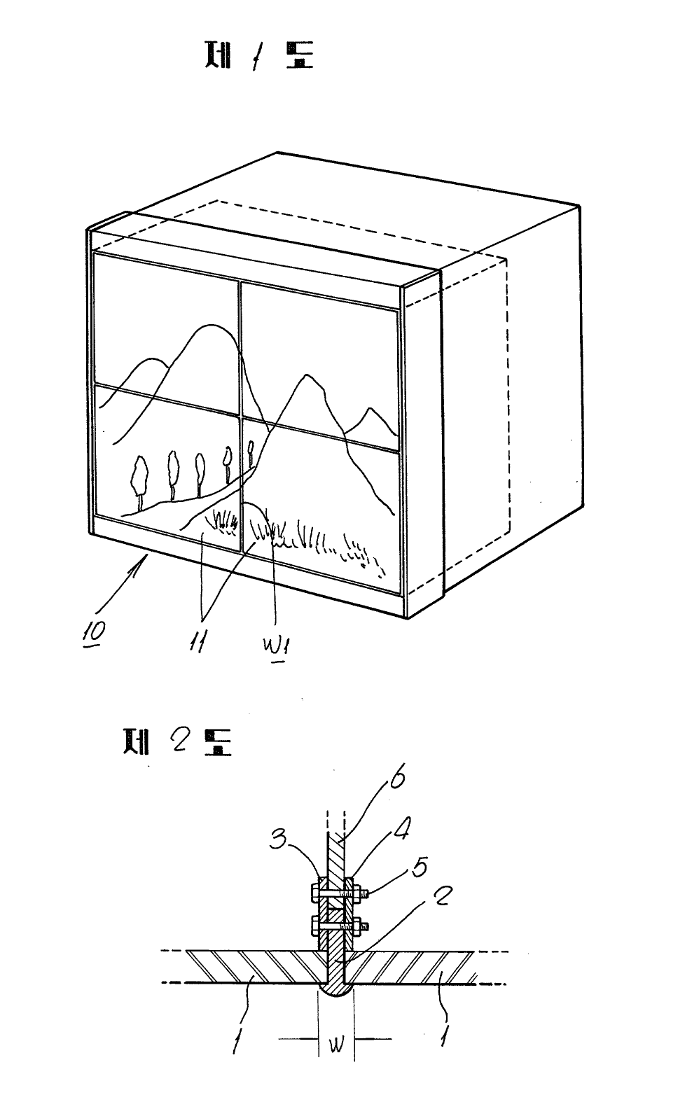

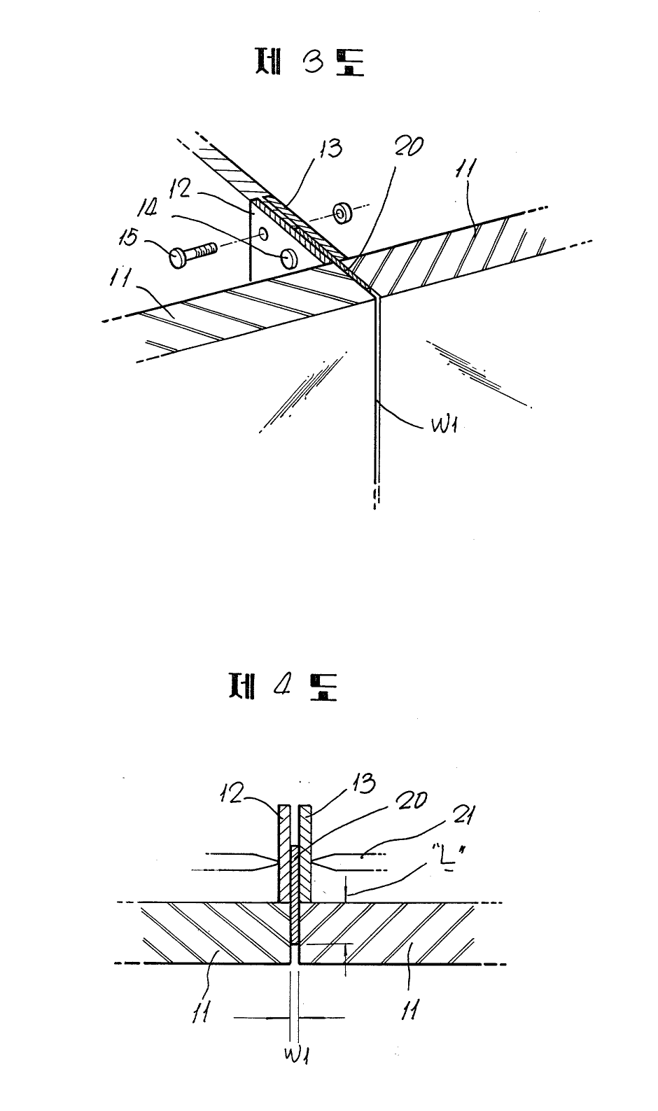

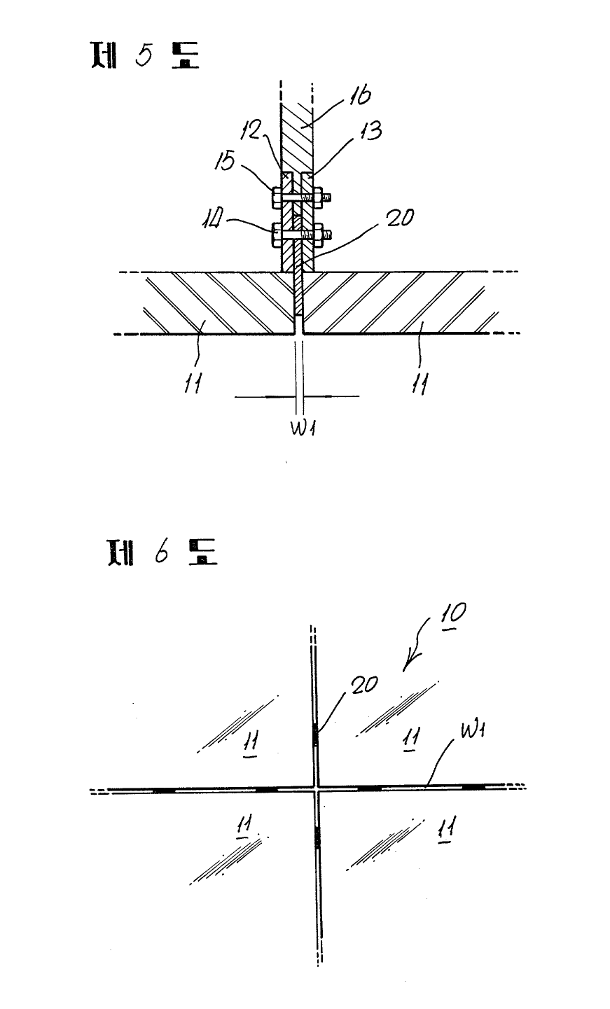

A detailed mechanism of the present invention is shown in FIGS. 1, 3, and others of the attached drawings and the present invention is equipped with many square screens 11 in parallel on the right and left or above and below on the frontal surface of multiscreens 10 equipped with square box-type forms.

These elements are to have the same as with the previous ones and the present invention relates to the elements that fix the above screens 11 in parallel on the right and left or above and below, which are equipped with membrane-type connecting pieces 20 fixed in equidistance between the screens.

At the time, the above connecting pieces 20 are elements of metal having a very thin thickness of below 0.5 mm and these connecting pieces 20 are installed with about ⅔ thickness between screens 11.

Also, on the said connecting pieces 20, an electrical heater 21 is brought into contact to apply electrical heat, and thereby, the surface of screens 11 of contact intervals (L) which are in contact with connecting pieces 20, is to be fixed and installed on connecting pieces by heat fusion and the said connecting pieces 20 are fastened and fixed on fixing brackets 12 and 13 of screens 11 by means of fixing bolts 14. And, partitioning plates 16 are fixed at the rear side of fixing brackets 12 and 13 again with fixing bolts 15.

Following is a detailed description of the effect of action of the present invention as mentioned in the foregoing through the drawings attached herewith.

As seen in FIG. 4 of the attached drawing of the present invention, connecting pieces 20 are inserted between screens 11 and brought to contact with electrical heater 21 to apply heat. Then, through connecting pieces 20 of good heat conductivity, heat is conducted and as the sides of screens 11 of plastic material which are bordered with the said connecting pieces 20 are fused into a single body as the said plastic screen sides are melted by the heat.

As in the foregoing, when both screens 11 are fused together by heat through connecting pieces 20 between the screens, only the intervals (W1) equivalant to thickness of connecting pieces 20 of very thin membrane type, are to appear on the frontal surface of the multiscreens. Under this condition, by means of fixing brackets 12 and 13 to be provided at the rear of screens 11, fixation is effected with fixing bolts 14 and also at the rear of this, partitioning plates 16 are to be connected by means of fixing bolts 14.

Therefore, the present invention, as described above, is to have an effect of advancing the fixing capability of screens by mutually connecting each of multiscreens with the method of heat fusion by means of membrane type connecting pieces.

Also, between the above screens, only the intervals equivalent to the thickness of the membrane-type connecting pieces are maintained and thereby making it look like a single screen which is used as a whole, i. e., an effect that no rim appears between the screens and because of this, mutual intervention of projector beams are eliminated so as to produce the effect of making picture planes more clear.

### SUMMARY

The present invention relates to the fixing device for fabricable rear projection-type multiscreens that enhance the commercial value of the product by increasing the connecting strength of screens and by minimizing the space between screens through the improvement of the connecting mechanism of many screens in the rear projection types of computers or projectors; metal membrane-type connecting pieces 20 of thickness below 0.5 mm are inserted between the said screens 11; heat is applied through connecting pieces 20 to cause the sides of screens 11 to be fused by melting with connecting pieces 20; and the above-mentioned connecting pieces 20 are connected and fixed to partitioning plates 21 with fixing bolts 14 and 15 by means of fixing brackets 12 and 13.

Scope of claims for registration of utility model:

1. In the mechanism of the rear-projection type multi screens equipped in parallel with many pieces of square screens at the front on the left and right or above and below.
The fixing device of the fabricable rear projection type multiscreens characterized by connecting and fixing partitioning plates 21 with fixing bolts 14 and 15 by means of connecting brackets 12 and 13 at the above-mentioned connecting pieces 20, by making it possible to effect a heat fusion of connecting pieces 20 with melting sides of screens 11 with an application of heat through connecting pieces 20 after inserting thin metal membrane type connecting pieces of thickness below about 0.5 mm between the connection points of the above screens.
